(19) United States
(12) Patent Application Publication
(10) Pub. No.: US 2004/0237612 A1
(43) Pub. Date: Dec. 2, 2004

(54) Lock with cylinder incorporating laterally biased bar engaging corresponding key

(76) Inventor: Walter Joseph Nugent, Victoria (AU)

Correspondence Address: CONNOLLY BOVE LODGE & HUTZ LLP, SUITE 800, 1990 M STREET NW, WASHINGTON, DC, 20036-3425, US

(21) Appl. No.: 10/491,475

(22) PCT Filed: Oct. 18, 2002
(86) PCT No.: PCT/AU02/01413

(30) Foreign Application Priority Data
Oct. 19, 2001 (AU) PR8387

(51) Int. Cl. E05B 25/00

(52) U.S. Cl. 70/382

(57) ABSTRACT

A lock and key set in which the lock includes a cylinder rotatable in a barrel which barrel is rotatable to actuate the latch wherein the cylinder incorporates a laterally spring biased bar which includes slots or projections adapted to engage with corresponding slots or projections on the keys so that the bar can be aligned in one of three positions in which its ends are within the diameter of the cylinder or one of each end of the bar projects beyond the cylinder to engage with the barrel. This is applicable to pin tumbler locks and locks of the type in which a latch means is actued by movement of actuating members through associated slots in latch elements there being two sets of latch elements such that when the slots in each set of elements are aligned, the actuating members can pass through. One set of latch elements are positioned by a setting key and the other set are positioned by a corresponding access key.

### BACKGROUND TO THE INVENTION

It has been a desirable feature of locks that they be able to be rekeyed without changing the lock. Another desirable feature is a lock that has a master key and subordinate keys which do not need a new lock mechanism when one of the keys needs to be replaced.

U.S. Pat. No. 4,741,188 discloses a pin tumbler lock in which keys can be replaced without changing the locks. This lock can also have a master key and subordinate keys. One difficulty with pin tumbler locks is the cost of manufacture because of the skilled machining and complex assembly required.

U.S. Pat. No. 4,898,011 disclosed an alternative lock to the pin tumbler which also avoided the need to change the lock. Instead of the key aligning pins to enable rotation of a cylinder the key aligned pins with slots so that elongate members could pass through to allow actuation of a latch. Each key had an associated biscuit which set one set of pins in position and the matching key aligned slots in a second set of pins with the slots of the first set. Master keying was possible by using more than one slot per pin.

Patent specification WO98/40589 discloses a programmable cylinder lock capable of having one or more levels of master key and able to be rekeyed. The cost of making such a lock and the capital cost of the machinery required to make it is very high.

Locks with deadbolts can be dangerous where they are deadlocked from both sides of the door. It is also desirable in a multi key environment to restrict the ability to deadbolt a door to a master key. A similar benefit is desired with night latches so that only one key holder can double lock the latch. Thus there is a need to provide a lock which enables some functions to be carried out by a different key.

U.S. Pat. No. 4,506,530 discloses a lock with a servant key that can throw the bolt to a first position and open it and a master key that can throw the bolt to a deadlock position. This is achieved by the presence of a dogging slide that restricts the servant key rotation but is displaced by the master key.

U.S. Pat. No. 4,704,884 discloses a pin tumbler cylinder lock with a rotary plug a control plug and a stationary plug. A first key can rotate the rotary plug counterclockwise 90°, the second key rotates the control and rotary plug clockwise 90°. the master key rotates the rotary plug the control plug and the master plug 360° in either direction. Thus 3 different functions can be actuated by 3 different keys. By simply inserting the appropriate key rotation in a given direction is possible to achieve a desired function. This arrangement is expensive to manufacture in terms of production tooling and machining costs.

It is an object of this invention to provide an inexpensive lock that provides a mechanism to enable different keys to carry out the different functions on the same lock

### BRIEF DESCRIPTION OF THE INVENTION

To this end the present invention provides a lock and key set in which the lock includes a cylinder rotatable in a barrel which barrel is rotatable to actuate the latch and the cylinder incorporates a laterally biased bar which incorporates slots or projections adapted to engage with corresponding slots or projections on the keys so that the bar can be aligned in one of up to three positions in which its ends are within the diameter of the cylinder or one of each end of the bar projects beyond the cylinder to engage with the barrel.

This means that the functions available can be distributed amongst 3 different keys each of which will place the lateral bar into a different position corresponding to a different function. If only two different keys are required then the lateral bar can be dimensioned so that there are only two positions namely co-terminal with the cylinder circumference or extending from one side only.

When the lateral bar is co-terminal with the cylinder diameter the cylinder can be removed from the barrel and this enables the cylinder to be adjusted or replaced. This invention is especially applicable to the lock arrangement wherein the lock is of the type in which a latch means is able to be actuated if elongated members are able to pass through associated slots in latch elements, wherein the latch elements are positioned by a key.

This type of lock is described in U.S. Pat No. 4,898,011 and enables master keying at more than one level to be achieved. The content of U.S. Pat. No. 4,898,011 is incorporated herein by reference.

When the end of the lateral bar extends beyond one end of the cylinder, rotation of the cylinder may actuate the latch. This is a function which would be common to all key holders.

When the end of the lateral bar extends in the opposite direction, rotation of the cylinder by the appropriate key may actuate another lock function such as throwing a deadbolt or a night latch which is a function reserved for a master key. Thus the lateral bar can be moved into one of up to three positions. Each of the two positions in which an end of the lateral bar extends beyond the cylinder circumference enables two possible functions to be carried depending on the direction of rotation of the key in the cylinder. Thus it is conceivable that their may be 5 functions that are possible to be carried out from the 3 different positions possible for the lateral bar. This would be easily achieved where the cylinder is used in an electric actuated lock.

This arrangement may be used with a cylinder in a pin tumbler lock. Preferably it is used in a lock of the type in which a latch means is able to be actuated if elongated members are able to pass through associated slots in latch elements there being two sets of latch elements such that, when the slots in each set of elements are aligned, the actuating members can pass through, wherein one set of latch elements are positioned by a setter which effectively programs the lock and the other set are positioned by a key that corresponds to the shape of the setter to align the slots of corresponding elements in each set. This is a lock of the kind described in U.S. Pat. No. 4,898,011. When the cylinder is removed the biscuit or programmable setter can be replaced, which means that the key that can be used to remove the cylinder is the code changing key.

In another aspect of this invention there is provided a lock and key in which the lock has a keyway and the base of the keyway is formed by a plate having an upstanding longitudinally extending rib that lies parallel to the base of the key wherein the base of the key and the longitudinally extending rib have complementary mating longitudinally extending protrusions and recesses and the base plate is removeable from the lock. This provides a replaceable component of the lock that can be changed as part of a rekeying exercise. This provides a new range of combinations in addition to those provided by the arrangement of latch elements.

### DETAILED DESCRIPTION OF THE INVENTION

A preferred embodiment of the invention using the coding system disclosed in U.S. Pat. No. 4,898,011 will be described with reference to the drawings in which

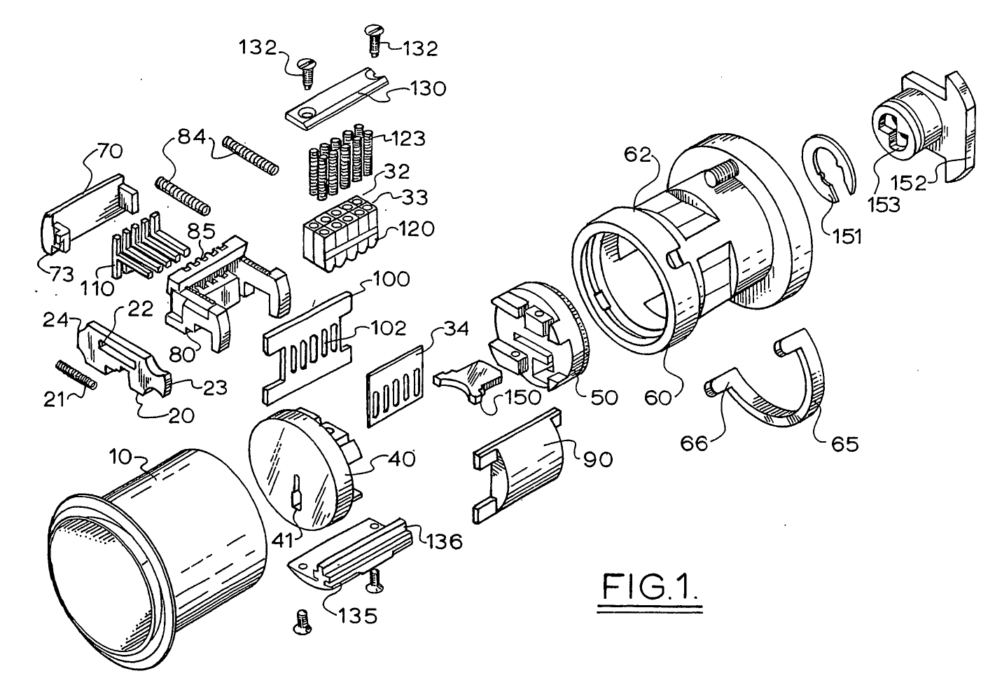

FIG. 1 is an exploded view of the cylinder and barrel arrangement for a night latch in accordance with one embodiment of this invention;

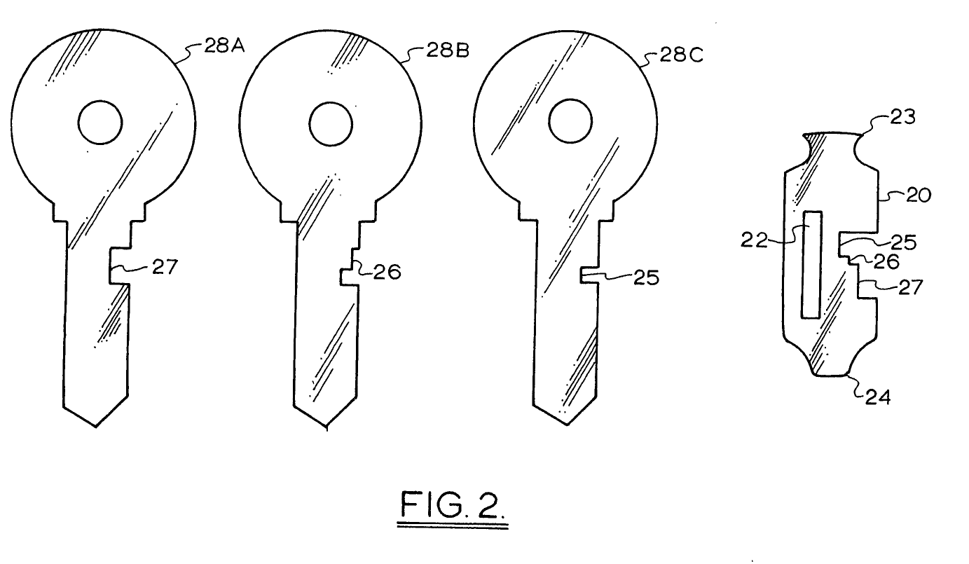

FIG. 2 is a schematic illustration of the keys and lateral bar configurations useful in this invention;

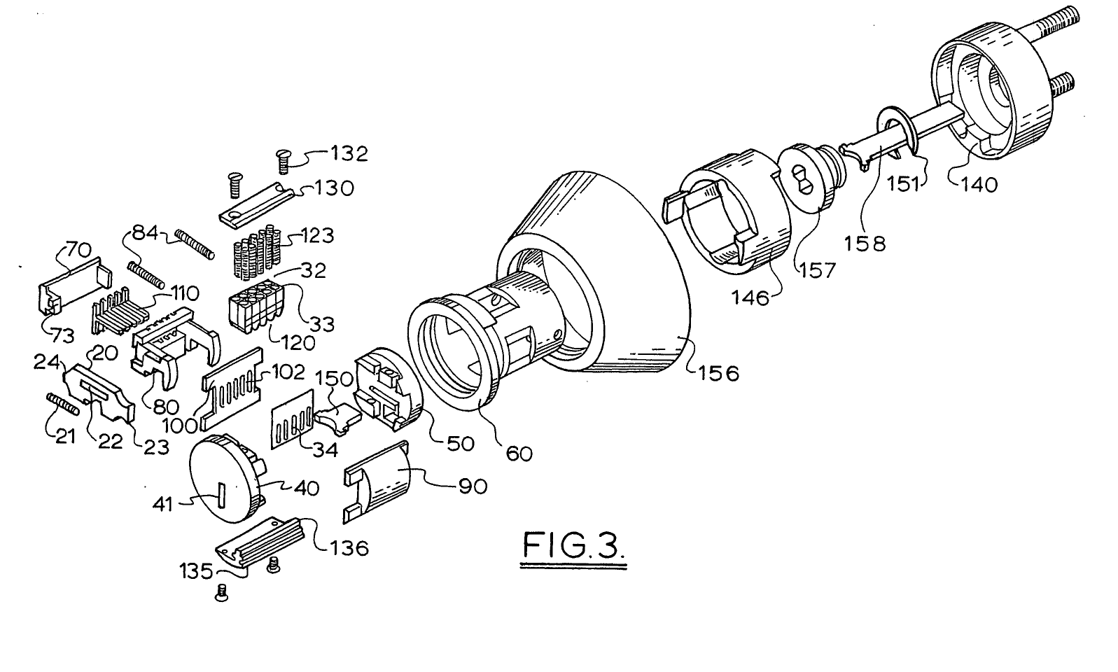

FIG. 3 is an exploded view of a deadbolt lock in accordance with another embodiment of this invention;

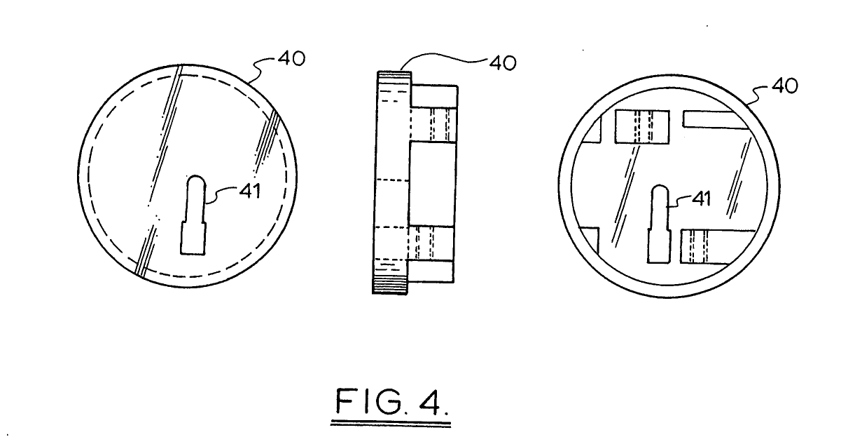

FIG. 4 is a set of views of the key plate;

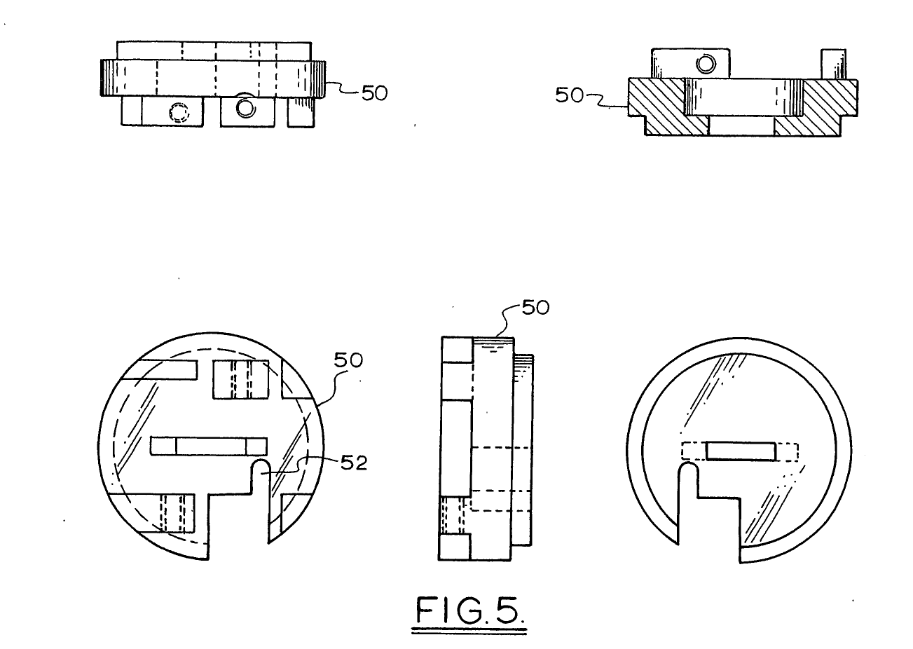

FIG. 5 is a set of views of the inner end plate to the key cylinder;

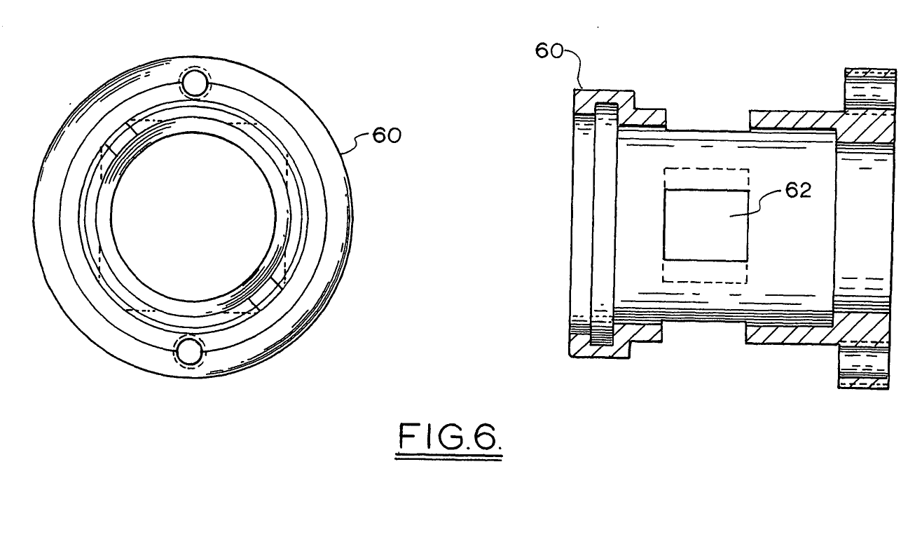

FIG. 6 is a pair of views of the cylinder body;

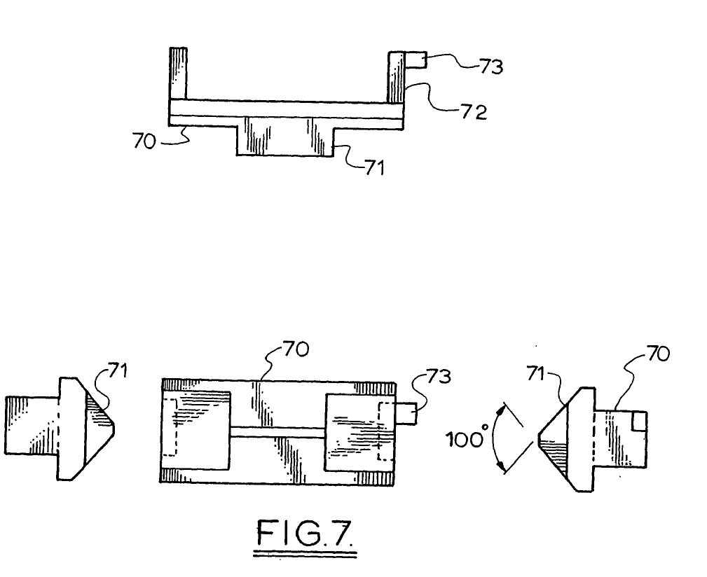

FIG. 7 is a view of the pawl which rotates within the cylinder body;

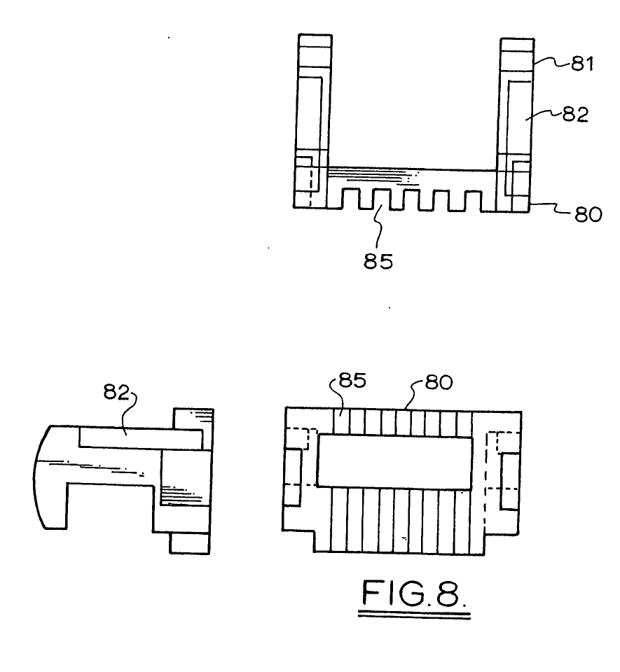

FIG. 8 is a set of views of the guide for the T pins;

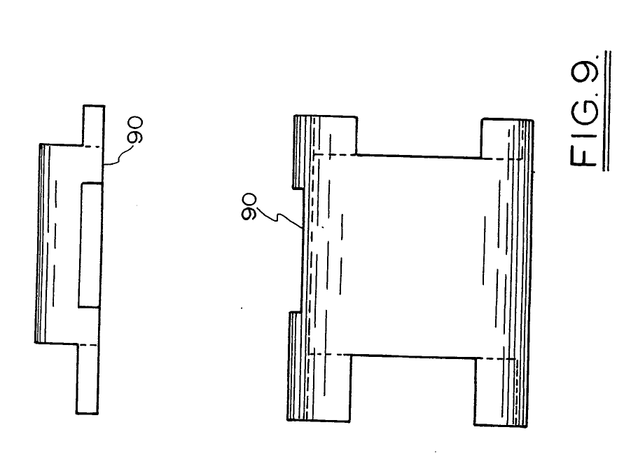

FIG. 9 is a set of views of the side plate at the end of the T pin guide arrangement;

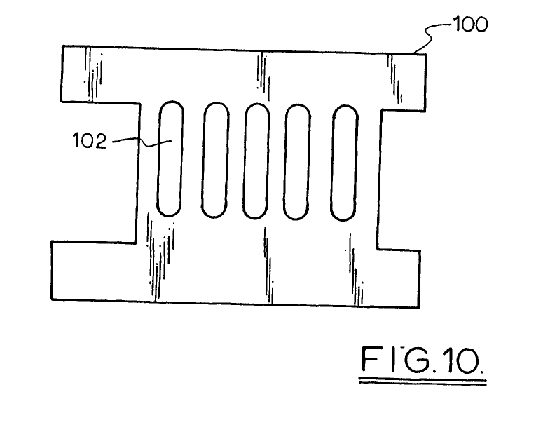

FIG. 10 is a set of views of the pin location plate;

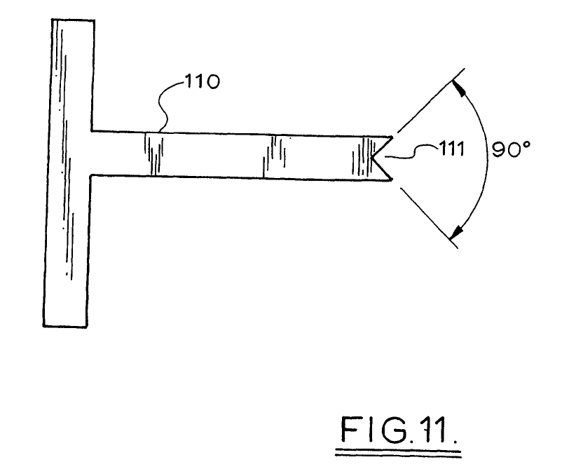

FIG. 11 is a pair of views of the T pins;

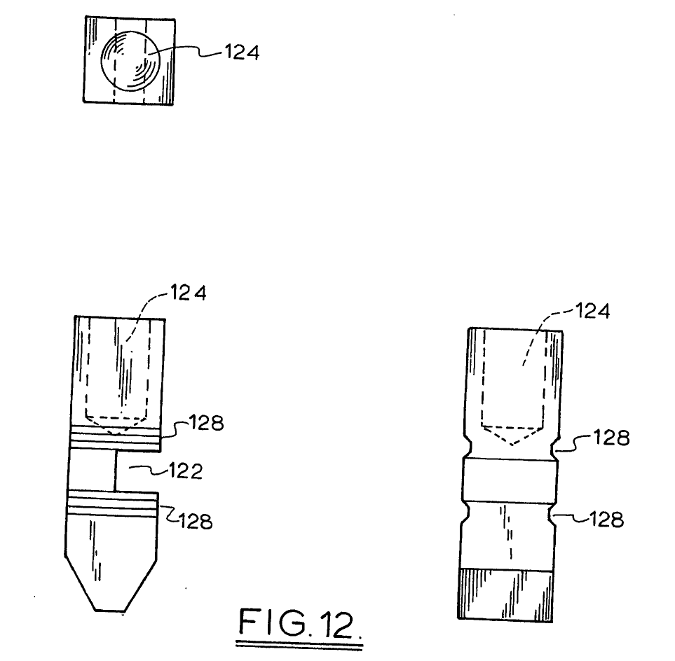

FIG. 12 is a view of one of the pins in the two sets of coding pins;

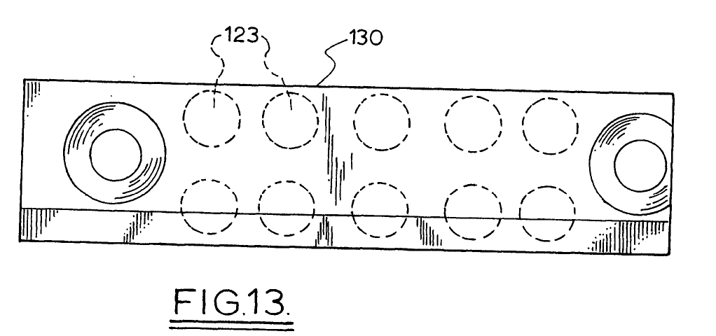

FIG. 13 is view of the spring top plate which covers the two sets of pins;

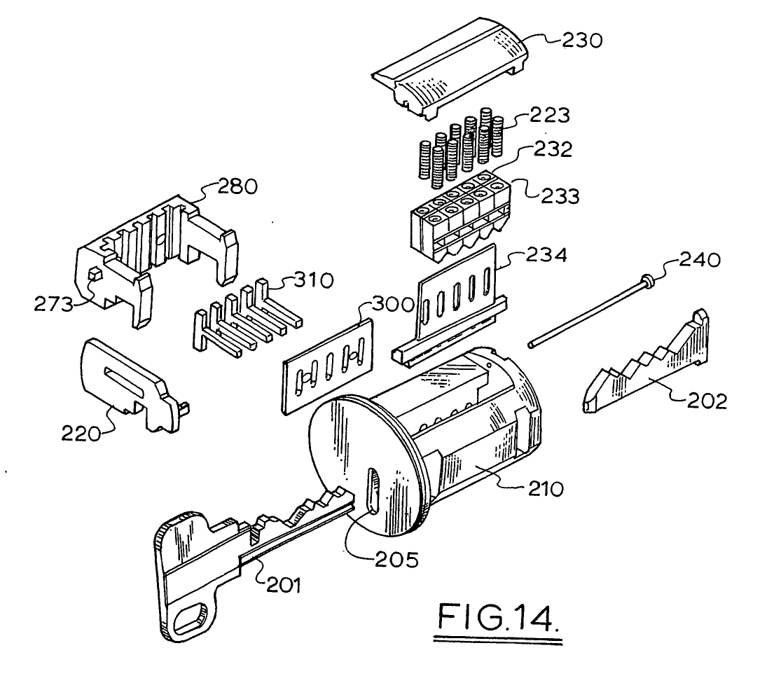

FIG. 14 illustrates another embodiment of the lock mechanism.

The latching mechanisms of the two locks in FIGS. 1 and 3 are conventional and based on commercially available lock mechanisms so that the cylinder and its components can be used to replace an existing cylinder.

The key code cylinder is defined by the end plates 40 and 50 held together by the spring top plate 130 and the bottom plate 135 all of which fit within the barrel 60 which in turn fits within the body 10 of FIG. 1 or the cone 156 shown in FIG. 3. The bottom plate 135 not only functions to secure the end faces 40 and 50 but also acts as the floor of the key way for the setter and the key. The barrel 60 is fixed and the spring 65 on its circumference functions as part of the latch mechanism as described below. The key code cylinder contains the coding section defined by the pawl 70 and the pin location side plate 90. The pawl incorporates a wedge protrusion 71 on its outer face which protrudes through the window 62 of barrel 60 when the cylinder is in its neutral position. The coding section is made up of two rows 32 and 33 of latch pins 120 which are separated by a separation plate 34 and held between the pin location plates 90 and 100. The plate 100 incorporates elongate slots 102 for the T bars 110 to pass through. The pins 120 as seen in FIG. 12 each have a coding slot 122 for the passage of the T bars 110 which are held within the grooves 85 of the T bar slide or guide 80 and pass through the elongate slots 102 of the pin location plate 100. The T bar slide 80 [FIG. 8] incorporates springs 84 fitting within the grooves 82 in the side arms 81 of the T bar slide 80. These springs 84 abut against the ends of the screws 132 that also serve to fasten the top plate 130 to the code cylinder ends 40 and 50. The springs 84 urge the slide 80 away from the pin location plate 90. The T bar slide incorporates grooves 85 to guide the T bars 110. The T bars 110 [FIG. 11] are notched at their ends with a v slot 111 to make it difficult to probe and pick the lock. If in picking the lock the pins are biased upwardly the notched ends formed by the V slot 111 will engage one of the grooves 128 which lie immediately above and below the coding slots 122 as shown in FIG. 12. This will cause the lock to stick and frustrate attempts to pick the lock.

The pins 120 [FIG. 12] are biassed downwardly by springs 123 which each fit into the cylindrical spring chamber 124 of each pin and abut the spring top plate 130. It is within the ambit of this invention to use a single leaf spring to bias the pins 120. As shown the coding slots 122 are formed in a wall of each pin which abuts the next pin to form an enclosed groove for passage of the t bars. This reduces the width of each pin and the length of each row of pins. However it is within the ambit of this invention to include one or more wider pins to accommodate a fully enclosed hole.

Rotation of the end plates 40 and 50 by the key 28 [FIG. 2] in the key hole 41 allows the inclined surface wedged protrusion 71 of the pawl 70 [FIG. 7] to be engaged by the cylindrical wall of the fixed barrel 60 and push the T bars 110 toward the pin location plate 90. If the slots 122 in the rows 32 and 33 of the pins 120 are aligned, the T bars can travel though to abut the plate 90 and thus allow the coding cylinder to rotate. Rotation of the end plate 50, which functions as a drive member, causes actuation of the latching mechanism via the tongue 150 engaging the slot 153 in the latch actuator 152 [FIG. 1].

The key way for the key 28 corresponds with pin row 32 and that of the code programming setter [not shown] with pin row 33. The key and setter will have matching slots to lift each pin in the rows 32 and 33 to matching incremental positions in the manner described in U.S. Pat. No. 4,898,011. When the key is fully inserted it allows rotation of the coding cylinder. The setter is inserted via the setter slot 52 in the end plate 50 and can only be accessed by removal of the coding cylinder. The setter may be inserted via a slot provided in the front plate 41 but for added security it is preferred to provide access via the end plate 50 which can only be accessed by removing the coding cylinder The bottom plate 135 which defines the keyway for key 28 and the setter has an upstanding rib 136 which lies between the key and the setter. This rib 136 may incorporate longitudinal ribs or grooves that engage with complementary ribs or grooves in the key 28 and setter and act as a further means of ensuring that the key and setter are correct. A different broach design with a different arrangement of longitudinal ribs and grooves on the upstanding rib 136 means that all new setters and keys will have to have a complementary broach arrangement. This provides a new range of combinations in addition to those provided by the arrangement of pins and can be used for different models of locks. Optionally, the bottom plate may be removeable, to provide a replaceable component of the lock, that can be changed as part of a rekeying exercise.

The functions which can be performed by the key 28 will depend on its interaction with the function slide 20 as shown in FIG. 2. The slide 20 incorporates a groove 22 which houses the spring 21. The spring 21 is biased by the flange 73 of pawl 70 [FIG. 7] which seats within the end of groove 22. The slots 25, 26 and 27 cut into the slide 20 seat into the corresponding slots on the keys 28A, 28B and 28C as shown in FIG. 2. Once the key 28 is inserted the slide 20 is positioned relative to the end face 40 so that its ends lie within the circumference of end face 40 or one of its ends 23,24 extends beyond the periphery of end face 40. Key 28 A with slot 25 positions the slide 20 so that the flange 23 protrudes beyond the circumference of the coding cylinder to engage with the stops on the latching mechanism. When no key is inserted the spring 21 biasses the slide 20 so that its flange 23 protrudes in the same position preventing removal of the cylinder. For the night latch of FIG. 1 or the deadlock of FIG. 3 the key 28A enables the latch to be opened or closed in its latching position. With reference to FIG. 1 the key 28A can only rotate the cylinder clockwise because of the engagement of the end23 with the flange 66 of the spring 65 fitted to the barrel 60. Key 28A is the common key used to gain entry.

Key 28B with slot 26 positions the slide so that its ends 23 and 24 are co-terminal with the circumference of the coding cylinder. This enables this key to be used to remove the cylinder primarily to change the setter.

Key 28C which incorporates slot 27 positions the slide 20 so that flange 24 protrudes beyond the circumference of the coding cylinder. This flange 24 engages the stop of the latching mechanism that prevents actuation of the latch knob of the night latch [FIG. 1] or throws the dead bolt to its fully extended position [FIG. 3]. This means that the throwing of the dead bolt can be reserved for one key .

In FIG. 15 an alternative mechanism is disclosed with a smaller number of parts.

The key 201 is inserted into the key way 205 of the lock body 210 while the setter 202 is inserted into a keyway on the opposite face of the body 210 to keyway 205.

Compared to the embodiment shown in FIG. 1 the differences are: The top plate 230 is shaped to better contain the springs 223 and pin rows 232 and 233

The T bar guide 280 is equivalent to the pawl 70 and T bar slide 80 of FIG. 1. the T bar guide 280 carries the T bars 310 and with plate 300 guides the movement of the T bars 310.the top plate is secured in position with the longitudinal pin 240. In other respects the embodiment of FIG. 15 functions similarly to the other embodiments.

Other variations may be made without departing from the core teachings of this invention. For example with reference to FIGS. 1 and 3 the top plate 130, the separation plate 34 and the bottom plate 135 may be formed as one piece to fit within a hollow body section.

From the above it can be seen that the present invention provides a keying arrangement which enables different keys to actuate different functions within the lock. The setter enables the lock to be rekeyed without having to change the code cylinder. A lock can be rekeyed by a new set of keys which would consist of a setter for the code cylinder, a cylinder removal key, a master key and as many common keys as is needed. Each of the keys will have the same code as the setter but differ in respect of the grooves which interact with the function slide 20. Because the number of moving parts in the lock as described above is much less than in a conventional pin tumbler lock it is easier to assemble. It is also possible to make most of the components by moulding which is less expensive than the machining required in pin tumbler locks.

1. A lock and key set in which the lock includes a cylinder rotatable in a barrel to actuate the latch the key having notches interacting with elements in the cylinder to actuate the lock wherein the cylinder additionally incorporates a laterally spring biased bar which includes slots or projections adapted to engage with additional corresponding slots or projections on the keys so that the bar can be aligned in one of up to three positions in which its ends are within the diameter of the cylinder or one of either end of the bar projects beyond the cylinder to engage with the barrel.

2. A lock and key set as claimed in claim 1 wherein the lock is of the type in which a latch means is able to be actuated if elongated members are able to pass through associated slots in latch elements, wherein the latch elements are positioned by a key.

3. A set of keys usable in the lock and key set defined in claim 1.

4. A lock and key set as claimed in claim 2 wherein the lock is of the type in which a latch means is able to be actuated if elongated members are able to pass through associated slots in latch elements there being two sets of latch elements such that, when the slots in each set of elements are aligned, the actuating members can pass through, wherein one set of latch elements are positioned by a setter which effectively programs the lock and the other set are positioned by a key that corresponds to the shape of the setter to align the slots of corresponding elements in each set.

5. A set of keys and a setter usable in the lock and key set defined in claim 4.

6. A lock and key in which the lock has a keyway and the base of the keyway is formed by a plate having an upstanding longitudinally extending rib that lies parallel to the base of the key wherein the base of the key and the longitudinally extending rib have complementary mating longitudinally extending protrusions and recesses.

7. A lock and key set as claimed in claim 6 wherein the lock is of the type in which a latch means is able to be actuated if elongated members are able to pass through associated slots in latch elements, wherein the latch elements are positioned by the key.

8. A removeable key way base plate adapted to be used in a lock and key set as defined in claim 6.

9. A lock and key set wherein the lock is of the type in which a latch means is able to be actuated if elongated members are able to pass through associated slots in latch elements there being two sets of latch elements such that, when the slots in each set of elements are aligned, the actuating members can pass through, wherein one set of latch elements are positioned by a setter which effectively programs the lock and the other set are positioned by a key that corresponds to the shape of the setter to align the slots of corresponding elements in each set and the latch elements are arranged in a cylinder so that the elongated members move laterally of the cylinder axis and the key and setter are inserted parallel to the cylinder axis.

10. A lock and key set as claimed in claim 1 in which the elongated members are biased to project associated members beyond the cylinder circumference when the two sets of elements are not aligned to prevent rotation of the cylinder and to retract the associated members when the elongated members pass through the aligned slots in both sets of latch elements.
